(19) United States
(12) Patent Application Publication
(10) Pub. No.: US 2015/0325866 A1
(43) Pub. Date: Nov. 12, 2015

(54) GAS SEPARATION FROM FUEL CELL COOLING WATER

(71) Applicant: GOODRICH CORPORATION, Charlotte, NC (US)

(72) Inventor: Jonathan Daniel O'Neill, Manchester, CT (US)

(73) Assignee: GOODRICH CORPORATION, Charlotte, NC (US)

(21) Appl. No.: 14/270,416

(22) Filed: May 6, 2014

(51) Int. Cl. H01M 8/04; B63H 21/38; B63G 8/00

(52) U.S. Cl. CPC H01M 8/04044; H01M 8/04029; H01M 8/04097; B63G 8/00; B63H 21/383; H01M 2250/20; B63G 2008/002

(57) ABSTRACT

A fuel cell has an anode and a cathode separated by a membrane. A source of fuel is provided for passing a fuel across the anode. A source of oxygen containing gas is provided for passing oxygen across a cathode. A cooling water circuit is associated with an accumulator and for supplying cooling water to cool the cathode, and to return the cooling water from the cathode back to the accumulator. A system removes entrained gases from the water returned to the accumulator and returns the removed gases to the cathode. A vehicle with such a fuel cell is also disclosed.

### BACKGROUND OF THE INVENTION

This application relates to methods and systems that facilitate the separation of fuel cell gases from cooling water.

Fuel cells are known and, typically, include a cathode and anode separated by a membrane. A fuel supply supplies a fuel, such as hydrogen, across the anode. An oxygen containing gas is driven across the cathode. The oxygen containing gas may be oxygen, air, or some other gas including oxygen.

Cooling water is driven across the cathode, often separate from the cathode by a wick layer. As part of the process, the gases, such as hydrogen and oxygen, may become entrained in the cooling water.

For a number of reasons, it is not desirable to have these gases entrained in the cooling water. In many fuel cell applications, the gases are simply allowed to escape from the cooling water, such as at a cooling water accumulator. Such applications may be vehicles utilized on land.

However, there are other applications wherein the vehicle containing the fuel cell is not allowed to have any waste emissions.

### SUMMARY OF THE INVENTION

A fuel cell has an anode and a cathode separated by a membrane. A source of fuel is provided for passing a fuel across the anode. A source of oxygen containing gas is provided for passing oxygen across a cathode. A cooling water circuit is associated with an accumulator and for supplying cooling water to cool the cathode, and to return the cooling water from the cathode back to the accumulator. A system removes entrained gases from the water returned to the accumulator and returns the removed gases to the cathode.

A vehicle with such a fuel cell is also disclosed.

These and other features may be best understood from the following drawings and specification.

### BRIEF DESCRIPTION OF THE DRAWINGS

FIG. 1 shows a prior art vehicle.

FIG. 2 shows a first embodiment.

FIG. 3 shows a feature that can be incorporated into the first embodiment.

FIG. 4 shows a second embodiment.

FIG. 5 shows yet another embodiment.

FIG. 6A shows another embodiment.

FIG. 6B shows the FIG. 6A embodiment in a second position.

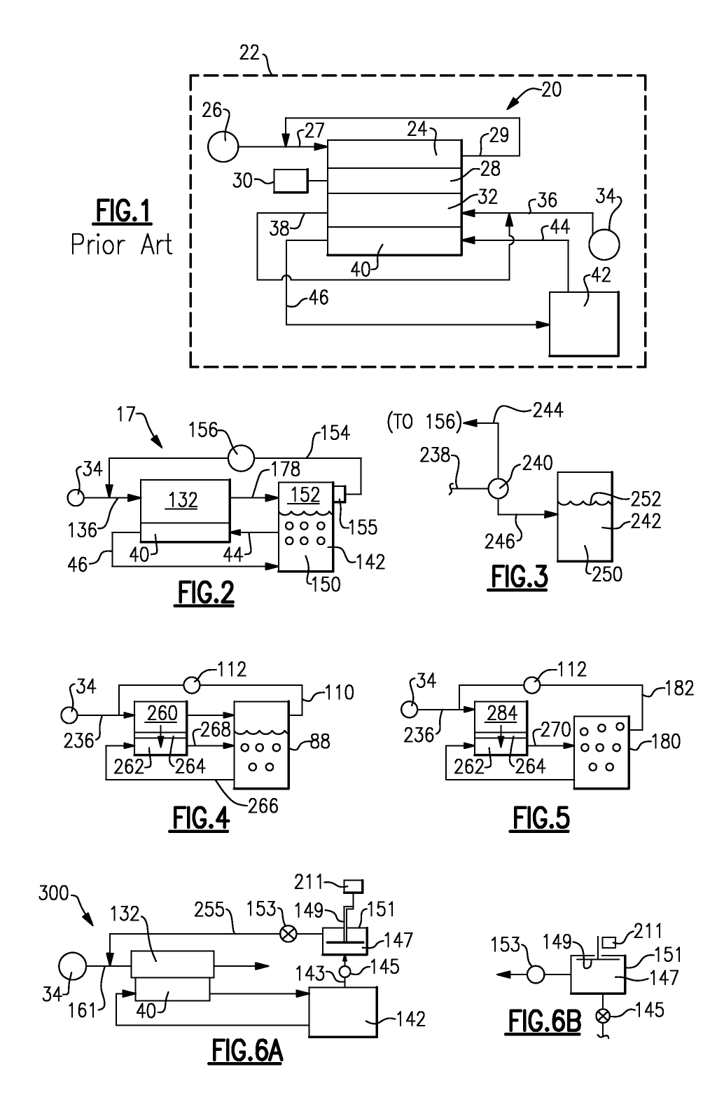

### DETAILED DESCRIPTION

A fuel cell 20 is shown schematically mounted within a vehicle 22, which may be an underwater vehicle, such as an unmanned underwater vehicle.

An anode 24 receives a supply of fuel 26 and an inlet 27 leads across the anode 24. An outlet 29 returns the fuel to the inlet 27. The fuel may be hydrogen in some applications. A membrane 28 separates the anode 24 from a cathode 32. The cathode 32 receives a supply 36 of an oxygen containing gas, such as from an oxygen tank 34. It should be understood the oxygen containing gas may also be air or oxygen mixed with nitrogen, or some other carrier gas. The oxygen containing gas is returned at 38 to the inlet 36. A cooling water channel 40 may cool the cathode. A water accumulator 42 supplies water through an inlet 44 to the cooling water channels 40 and a return line 46 returns the water.

As known, energy is generated by the fuel cell 20 and delivered to a use 30. This aspect may be as known in the prior art.

As the fuel cell 20 operates, fuel and oxygen may pass into the cooling water flow and be mixed within the water. This can become undesirable and may result in the pressure within the accumulator 42 increasing to undesired levels.

Thus, as shown in FIG. 2, a system 17 may include a cathode 132 receiving an inlet supply 136 of oxygen containing gas from a tank 34. A recycle line 178 may pass through a water accumulator 142 and back through a line 154. A pump 156 may be included on line 154 to return the recycled oxygen containing gas to the inlet 136. As used in this application, the term “pump” should be interpreted to extend to any liquid movement device, including a fan, an ejector, etc. As shown, a water inlet line 44 communicates water from an interior of the tank 142 to the water cooling channels 40, and then to a return line 46. As can be seen, the accumulator 142 includes a gas containing area 152 and a water level 150. A porous plug 155 may communicate with the gas level 152 and ensure that only gas passes to the return line 154. The plug may be Teflon® or another hydrophobic device. That is, should there be any water entrapped in the gas containing area 152, that water will be separated.

Over time any entrapped oxygen or hydrogen in the water in accumulator 142 will be removed in this matter and returned across the cathode 132.

If oxygen is the gas in the tank 34, the gas passing through the recycle line 138, 154 will be largely oxygen. On the other hand, the recycle line may be charged with a carrier gas. In fact, if air is the “oxygen containing gas,” the gas at 178, 152, 154 will be largely nitrogen other than the gases removed from the water.

In either instance, it is desirable to minimize the percentage of hydrogen which may be entrained in this gas. As an example, hydrogen may be maintained at a fraction of less than 5%.

FIG. 3 shows a modification wherein water return line 238 approaching an accumulator 242 is passed through a liquid separator 240, which separates the return flow into a water containing path 246, and a gas path 244. The gas path 244 is directed to the cathode inlet, using pump 156. The path 246 is returned to the accumulator 242, and into a liquid area 250.

FIG. 4 shows an embodiment wherein a cathode 260 is provided with a wick layer 264 communicating with the water cooling channels 262. An accumulator 88 sends water through a supply line 266 to the cooling channel 262 and receives the return water through a line 268. Oxygen containing gas from tank 34 passes through inlet 236 and into a connection 110, and a pump 112 returns that oxygen containing gas to the inlet 236. In this embodiment, no porous plug is relied upon.

In the FIG. 4 embodiment, water is allowed to intermix with the gas passing into line 110. That water will pass across the wick layer 264 and be returned to the water cooling channel 262. In this manner, the gas entrained in the accumulator 88 is reused at the cathode 260 while the water is separated.

FIG. 5 shows an embodiment which is somewhat similar to the FIG. 4 embodiment, however, the cathode 284 exit is not connected to the coolant accumulator 180. The accumulator 180 is shown full of water. As understood, gases will accumulate within the water, and that water and entrained gases are driven by a pump 112 through the line 182 back to the inlet 236. Again, the water will pass across the wick layer 264, and be returned to the accumulator 180 while the gases will be utilized at the cathode 284.

FIG. 6A shows yet another embodiment 300. In embodiment 300, the cathode 132 and the cooling channel 40 may be fluidly separate. However, the accumulator 142 is provided with a tap 143 at a vertically upward layer. The tap 143 passes through a valve 145 into an expanding chamber 151. Thus, as gas is separated from the water in the accumulator 142, it passes through the line 143, an open valve 145 and into a chamber 147 beneath a piston 149 in the expanding chamber device 151.

It should be understood the expanding chamber device 151 could be a bladder or bulb, and would operate in the same manner. A valve 153 is positioned on a return line 255 and is shown closed in the FIG. 6A position. A control 211 senses the position of the piston 149 which, in turn, is an indication of the volume of gas stored within the expansion chamber 151. When the piston 149 has been driven upwardly by gas, such that the control 211 now senses the piston has generally moved to indicate the chamber 151 is largely full, the valve 145 may be closed, the valve 153 opened. The piston 149 is driven by an actuator incorporated with control 211 to reduce the volume of the chamber 151 and drive the gas in chamber 147 through the valve 153 back to the inlet 161 leading to the cathode 132.

Generally, several embodiments have been disclosed which will remove gases from the cooling water and return them to the fuel cell for use. In this manner, no waste emission is required.

It should be understood that the fuel could be entrained as part of the removed gases, and in that sense, the gases are not “returned” to the cathode, but instead sent to the cathode. Still, the oxygen removed would be returned to the cathode. While the disclosure shows sending the removed gases to the cathode, it should be understood that in certain applications, the removed gases can be sent to the anode.

Although an embodiment of this invention has been disclosed, a worker of ordinary skill in this art would recognize that certain modifications would come within the scope of this invention. For that reason, the following claims should be studied to determine the true scope and content of this invention.

1. A fuel cell comprising:
an anode and a cathode separated by a membrane;
a source of fuel for passing a fuel across said anode and a source of oxygen containing gas for passing across a cathode;
a cooling water circuit, said cooling water circuit being associated with an accumulator, and for supplying cooling water to cool said cathode, and return the cooling water from the cathode back to the accumulator; and
a system for removing entrained gases from the water being returned to the accumulator and sending the removed gases to at least one of said cathode and said anode.

2. The fuel cell as set forth in claim 1, wherein said at least one of said cathode and said anode is said cathode.

3. The fuel cell as set forth in claim 2, wherein the system includes an oxygen containing gas return line for said oxygen containing gas that passes through said accumulator to remove and return gases to said oxygen containing gas inlet.

4. The fuel cell as set forth in claim 3, wherein a separator plug is placed on the accumulator and removes water from the oxygen containing gas return line as it leaves the accumulator.

5. The fuel cell as set forth in claim 2, wherein a water separator separates water and entrained gas prior to the removed gases being sent to said cathode.

6. The fuel cell as set forth in claim 2, wherein water and entrained gases are returned to said oxygen containing gas inlet, and the water is allowed to separate across a wick layer back into said cooling water circuit, with said entrained gases being used at said cathode.

7. The fuel cell as set forth in claim 1, wherein said accumulator communicates through a tap line to an expansion chamber and such that the gases cause said expansion chamber to expand, and said expansion chamber being provided with a control such that when said expansion chamber reaches a predetermined volume, said expansion chamber is caused to reduce its volume and drive entrained gases back to said at least one of said cathode and said anode.

8. The fuel cell as set forth in claim 7, wherein a first valve is positioned upstream of said expansion chamber and on said tap line, and a second valve is positioned downstream of said expansion chamber device and on a line to said at least one of said cathode and said anode, with said first valve being open and second valve being closed until said expansion chamber reaches said predetermined volume, and said first valve then being closed and said second valve then being open, and said expansion chamber then being reduced in volume to drive the entrained gases.

9. A vehicle for use in underwater applications comprising:
the vehicle provided with a fuel cell; and
the fuel cell including an anode and a cathode separated by a membrane, a source of fuel for passing a fuel across said anode and a source of oxygen containing gas for passing across a cathode, a cooling water circuit, said cooling water circuit being associated with an accumulator, and for supplying cooling water to cool said cathode, and return the cooling water from the cathode back to the accumulator, a system for removing entrained gases from the water being returned to the accumulator and returning the removed gases to the cathode.

10. The vehicle as set forth in claim 9, wherein the system includes an oxygen containing gas return line for said oxygen containing gas that passes through said accumulator to remove and return said gases to said oxygen containing gas inlet.

11. The vehicle as set forth in claim 10, wherein a separator plug is placed on the accumulator and removes water from the oxygen containing gas return line as it leaves the accumulator.

12. The vehicle as set forth in claim 9, wherein a water separator separates water and entrained gas prior to the removed gases being returned to said cathode.

13. The vehicle as set forth in claim 9, wherein water and entrained gases are returned to said oxygen containing gas inlet, and the water is allowed to separate across a wick layer back into said cooling water circuit, with said entrained gases being used at said cathode.

14. The vehicle as set forth in claim 13, wherein said accumulator is generally full of water.

15. The vehicle as set forth in claim 9, wherein said accumulator communicates through a tap line to an expansion chamber and such that the gases cause said expansion chamber to expand, and said expansion chamber being provided with a control such that when said expansion chamber reaches a predetermined volume, said expansion chamber device is caused to reduce its volume and drive entrained gases back to an inlet for said oxygen containing gases.
